(19) United States
(12) Patent Application Publication
(10) Pub. No.: US 2016/0277616 A1
(43) Pub. Date: Sep. 22, 2016

(54) AUTOMATIC DOCUMENT FEEDER

(71) Applicant: VISION BOX - SOLUÇÖES DE VISÄO POR COMPUTADOR, S.A., Oeiras (PT)

(72) Inventors: Miguel LEITMANN, Oeiras (PT); Bento CORREIA, Oeiras (PT)

(21) Appl. No.: 14/442,630

(22) PCT Filed: Nov. 13, 2013
(86) PCT No.: PCT/PT2013/000066

§ 371 Date: May 13, 2015

(30) Foreign Application Priority Data
Nov. 13, 2012 (PT) 106640

(51) Int. Cl. H04N 1/00

(52) U.S. Cl. CPC H04N 1/00827; H04N 1/00604; H04N 2201/0063; H04N 2201/0081; H04N 2201/0422; H04N 2201/0434

(57) ABSTRACT

An automatic document feeder composed of a transparent sliding platform, side guides, longitudinal guides and a horizontal guide, a system of springs, a controller, a linear actuator, a protection bar, a rigid part, a set of bushings, bearings, document detection and motion sensors, and an end position sensor, a linear spring, a bobbin and a motor. The automatic document feeder can also be adapted to all types of document reader and reads flat and bulky documents alike. An operating method of the automatic document feeder is also disclosed.

### THE TECHNICAL SIDE OF THE INVENTION

The scanning of bulky documents such as passports currently requires the intervention of the user, due to the fact existing scanners are only capable of correctly scanning flat documents.

In relation to border control, specifically at airports, many scanners fail to scan documents accurately, largely due to the need for human intervention. The main problem is the correct positioning of the document, passports for example, where there is a need to push the same into position and hold it down in order to guarantee an accurate reading.

Several different alternative solutions have been tried out, namely the use of visual animation. However, these attempts merely reduced the margin of error and failed to deal with the problem involving the need for the user to intervene.

Hence, a solution was required for obtaining greater efficiency when scanning bulky documents.

This invention was conceived with this in mind, and ensures the automatic scanning of all types of document with no need for active human involvement.

### STATE OF THE ART

Nowadays the use of scanners with sliding drawers for scanning flat documents is common.

Some of the patents illustrating the state of the art in this area of technical invention include U.S. Pat. No. 5,790,278, DE29716637U and U.S. Pat. No. 6,157,466.

In the case of patent N° U.S. Pat. No. 5,790,278, the document to be scanned is placed on a tray which is later removed, the scan taking place while the document is being collected. However this mechanism only serves to scan flat documents.

Patent N° DE29716637U refers to a scanner featuring a mechanism which transfers the documents to the scan area. In this case the principal innovation is the fact the optical scanner features a mechanism for transferring the documents, but once again, only flat documents can be scanned.

Patent U.S. Pat. No. 6,157,466 corresponds to a computer scanner, and includes a mechanism composed of a drawer for withdrawing the document and subsequent scanning.

There is not one scanner in the current state of the art with a automatic feeder composed of a single platform for scanning bulky documents. Existing scanners are composed of drawers or trays for storing and transferring documents to the scanning area.

Furthermore, existing mechanisms involve the document being moved to the scanning area, whereas with this invention it is the platform itself which moves and not the document, thereby significantly reducing the risk of damaging the document.

### A SUMMARY OF THE INVENTION

This invention features an automatic transparent sliding feeder mechanism located on the upper part of a standard optical scanner. The transparent sliding mechanism feeds, moves and repositions any document, both flat and bulky, to the correct position over the standard reader to activate the optical, electronic or radio-frequency scanning process, with no need for the user to intervene and no risk of the document being damaged.

We intend to patent the working mechanism of the invention in addition to the mechanism itself. Thus, both the device and the working method of the device will be patented.

The main parts of the invention are a sliding platform, an optical sensor, side guides with a spring system, a controller, a document locking mechanism, a protection bar and a standard document reader.

One of the main advantages of the invention is the absence of friction between the document and the surrounding parts, due to the fact the document is transferred to the reading area on a sliding platform with no need for any sliding part placed on top of the document, meaning the document cannot become stuck to the part in question and undergo damage.

The invention is designed so documents placed on the platform and transferred (with the platform) to the reading position are always partially visible, enabling the user to remove the document during the reading/scanning without causing any damage to the document or the equipment.

The invention can be installed immediately above a standard document reader, whereby the reading process is activated by an external signal, or in other words, the document is placed on the mechanism by the user, whereby this and the collection of the document on conclusion of the scanning process is the only involvement of the user throughout the scanning process. The manner in which this mechanism is installed on the scanner gives the user the sensation of using one integrated piece of equipment, when in fact two different mechanisms are being used.

It is important to reiterate the work flow of the invention:
The user places the document on the transparent platform;
A sensor detects the document and the transparent platform slides into the mechanism;
A liner actuator pins the document to the transparent platform;
The document is read by a standard document reader;
After reading the transparent platform transports the document back to the initial position where it is collected by the user.

The following figures will provide a clearer idea of the invention:

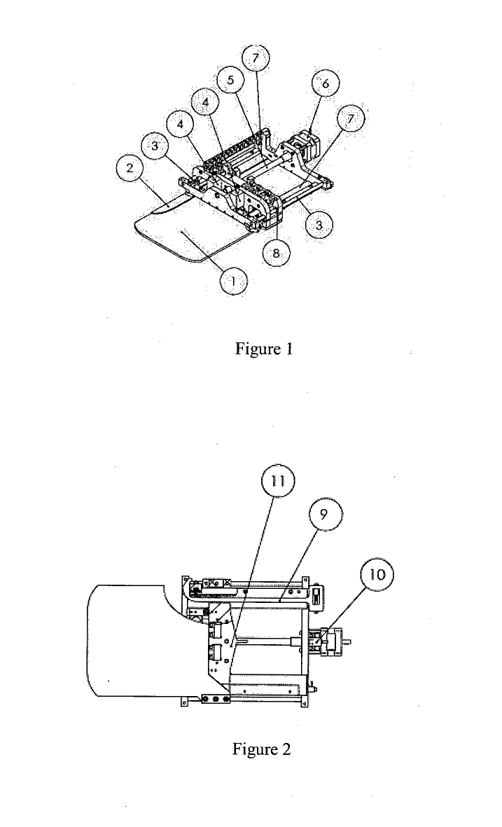

FIG. 1—an exterior view of the invention with the platform in the initial position.

FIG. 2—a cross-section view from below in order to illustrate the respective parts.

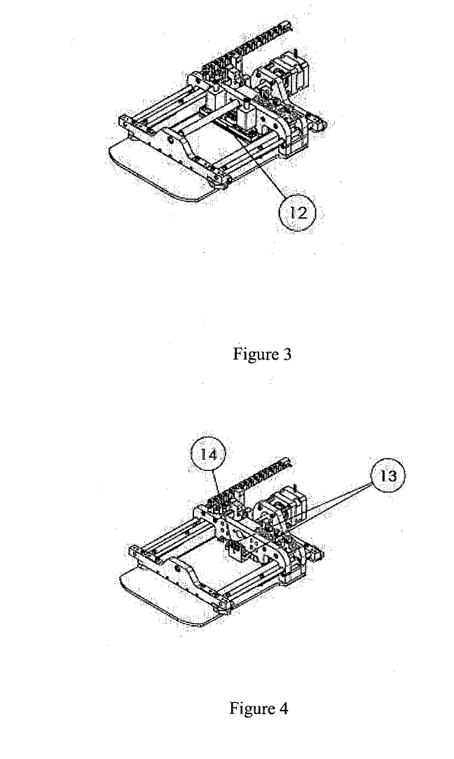

FIG. 3—illustrates the invention with all the parts in the reading position.

FIG. 4—shows the invention in the reading position with the parts hidden as a means of viewing the document sensors (13).

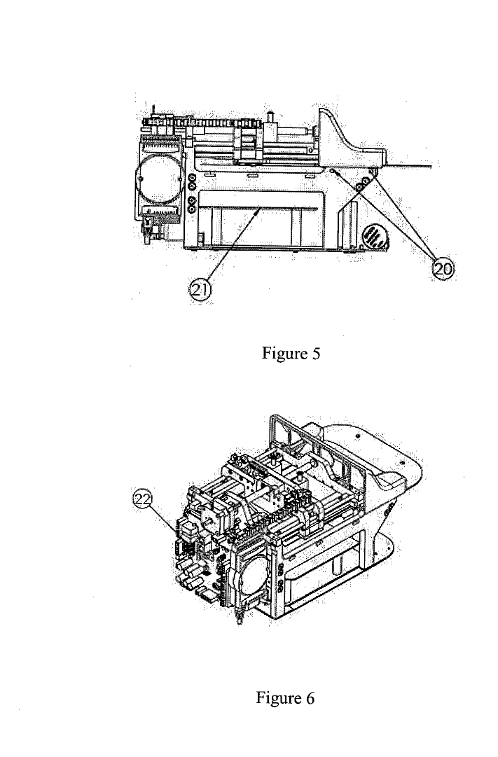

FIG. 5—a side view of the invention positioned on top of the document reader (21) and the remaining support structure.

FIG. 6—illustrates the complete structure of the invention and a standard document reader.

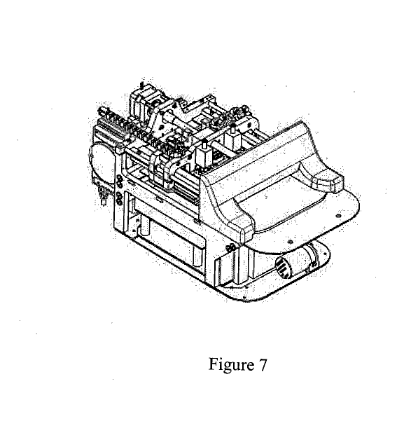

FIG. 7—an isometric illustration of the final assembly.

### A DETAILED DESCRIPTION OF THE INVENTION

We will now proceed with a detailed description of the invention using the sketches.

As mentioned previously, this invention is a mechanism for the automatic reading of documents, activated when the user places a document on the platform (1), this being the only human intervention in relation to the process. The documents to be read/scanned may be placed on the platform in any position (1) provided the side to be read is facing down (1). A motion sensor (13) is attached to the platform (1) and positioned in such a way it will detect any type of document, both flat and bulky.

Once the optical sensor (13) has detected the document a horizontal guide (2) using a system of springs (9) will place the document in the correct position.

When the document is placed on the platform (1) the spring-operated guide (2) moves the document to the left and the platform moves into the position for reading the document.

In order to prevent the document from becoming stuck in the space under the mouth of the apparatus, the system has been designed so the space between the platform (1) and the base of the invention is equivalent to approximately four sheets of paper.

When the optical sensor (13) detects the presence of the document it sends a signal to the controller (22), which, in turn, activates the linear actuator (4) by means of an electric signal.

The linear actuator (4) then pins the document to the tempered glass platform (1) with a frictional force of 30 N to prevent the passport from sliding around the glass platform. A linear spring (14) also helps hold the document in position. Together with the linear actuators, this spring ensures the system is capable of handling documents of different thicknesses and textures.

The force applied by the linear actuator (4) is specifically designed to hold the document firmly in place throughout the scanning process. Furthermore, the force applied enables the user to remove the document in the middle of the scanning process without damaging the same or the linear actuator (4).

In the event the user removes the document during the scanning process, the platform (1) will automatically return to the initial position once the optical sensor (13) no longer detects the presence of the document.

A protection bar (12) is attached to the platform (1) to prevent foreign objects from entering the equipment and moves in time with the platform.

A soon as the document is in the correct position on the platform (1), the linear actuator (4) sends a signal to activate the motor (6), whereby the movement is transferred to the platform (1) by means of a bobbin (5) which places the platform (1) in the position to read the document;

As a means of ensuring the platform (1) does not move out of position, the invention features side guides (3) to guarantee the document is correctly aligned, applying minimal friction on the mechanism, achieved by means of two sets of parallel bushings (8), one on each side of the equipment, in addition to two or four bearings (20) positioned on the base on which the platform (1) rests.

When the platform (1) reaches the reading position a rigid piece of plastic (11) activates the end position sensor (10), which, in turn, activates the reading/scanning of the document.

Bulky documents are pinned to the glass platform (1) by the pressure applied by the linear actuator (4) and the existence of longitudinal guides (7) which prevent the natural tendency of the document to close.

The document is read by a standard reader (21) which captures infrared and ultraviolet images in the visible spectra, guaranteeing a quality which enables the image to be processed on a computer program.

After the document has been read, the reader (21) sends an electric signal of confirmation to the controller (22), which will then assume the scanning process has been concluded and sends an electric signal to the linear actuator (4), which then releases the document and returns the platform (1) to the initial position to enable the user to collect the same from the platform (1).

1. An automatic document feeder comprising:
a transparent sliding platform;
side guides, longitudinal guides and a horizontal guide;
a spring system;
a controller;
a linear actuator;
a protection bar;
a rigid part;
a set of bushings;
bearings;
a document detection sensor, motion sensor and end position sensor;
a linear spring;
a bobbin; and
a motor.

2. The automatic document feeder as claimed in claim 1, defined as being adaptable to all types of document reader and installed immediately above the document reader.

3. The automatic document feeder as claimed in claim 1, defined as comprising a space between the platform and the base of the mechanism equivalent to approximately four sheets of paper.

4. The automatic document feeder as claimed in claim 1, defined by the sensor detecting both flat and bulky documents.

5. The automatic document feeder as claimed in claim 1, defined by a low level of friction—30 N—in the mechanism by means of the use of two sets of two parallel bushings, one on each side of the apparatus, in addition to two or four bearings located in the base on which the platform rests.

6. The automatic document feeder as claimed in claim 1, defined by the document being able to be removed by the user at any stage during the reading process.

7. The automatic document feeder as claimed in claim 1, operates in accordance with the following steps:
the user places the document on a platform with the side to be read facing down;
a motion sensor detects the document and sends a signal to the controller;
the document is repositioned on the platform by the horizontal guide using a system of springs which slide the document over to the left;
the linear actuator is activated on receiving an electronic signal sent by the controller, pinning the document to the transparent platform with the help of the longitudinal guides;
the linear actuator sends a signal to activate the motor, whereby the movement is transferred to the platform by means of a bobbin which places the platform in the position to read the document;
the document is now in the reading position and the end position sensor determines position zero, whereby the motor starts the pre-programmed rotations to begin reading the document;
the document is read by a standard document reader;
after reading, the reader sends an electronic signal to the controller, which, on receiving the signal assumes the scanning process has been concluded;
the controller sends a signal to the linear actuator and to the motor in order for the transparent platform to transfer the document to the initial position where it is collected by the user.
